(19) United States
(12) Patent Application Publication
(10) Pub. No.: US 2010/0222461 A1
(43) Pub. Date: Sep. 2, 2010

(54) EPOXY COMPOSITIONS WITH IMPROVED MECHANICAL PERFORMANCE

(75) Inventors: Christopher Lee Bongiovanni, Anaheim, CA (US); Jack Douglas Boyd, Silverado, CA (US)

Correspondence Address: CYTEC INDUSTRIES INC., 1937 WEST MAIN STREET, P.O. BOX 60, STAMFORD, CT, 06904-0060, US

(73) Assignee: CYTEC TECHNOLOGY CORP., Wilmington, DE (US)

(21) Appl. No.: 12/711,351

(22) Filed: Feb. 24, 2010

Related U.S. Application Data
(60) Provisional application No. 61/156,356, filed on Feb. 27, 2009.

(51) Int. Cl. C08G 59/14; C08L 63/00; C08L 77/00; C08L 1/00

(52) U.S. Cl. 524/35; 525/523; 525/533; 525/423; 525/449; 525/187; 525/471

(57) ABSTRACT

Polymer compositions capable of a high degree of curing at relatively low temperatures, and prepregs, adhesives, films and composites formed therefrom are discussed. The polymer compositions include epoxy resin systems and a dual curing system including one or more curing agents containing one or more hydrazine-based curing agents having hydrazine functional groups and one or more amine-based curing agents containing one or more amine functional groups. The hydrazine-amine curing systems enable the polymer composition to achieve elevated levels of gelation or degree of cure at lower temperatures than are achievable with amine functional curing agents alone. Furthermore, this elevated degree of curing of the polymer composition may be achieved with substantially no reduction in tack life and/or out life of the prepreg, adhesive or film or cured state mechanical properties of composites, adhesives or other products fabricated therefrom, such as open hole compression strength and compressive strength after impact. The glass transition temperature of the cured polymer compositions is similarly unaffected.

### BACKGROUND

1. Field

Embodiments of the present disclosure relate to epoxy polymer compositions and, in particular, to epoxy polymer compositions including hydrazine-based curing agents in combination with amine-based curing agents which epoxy polymer compositions exhibit an excellent balance of low temperature reactivity and mechanical properties.

2. Description of the Related Art

Polymer Matrix Composites (PMCs) are a class of structural material which combine selectively oriented fibers with a reinforcing polymeric matrix. These composite structures exhibit good mechanical properties for their weight, including strength, stiffness and fatigue. Coupled with ease of manufacture, these good mechanical properties provide PMCs with wide applicability in a variety of industrial applications, for example, aerospace and wind energy.

Research is ongoing to develop epoxy polymer compositions as matrix resins for use in composites, adhesives, and surfacing films that are capable of curing or polymerizing at relatively low temperatures but still have good out life and mechanical properties. The ability of a composite structure to cure at low temperatures provides a variety of benefits. In one aspect, tooling which are employed to shape the composites, such as molds, may be formed from lower cost, low temperature materials, rather than more expensive materials capable of withstanding higher curing temperatures. Further, curing at relatively low temperatures may, inhibit void formation. Relatively low temperature curing can also be advantageous for vacuum-only composite processing because of the afore-mentioned advantages.

Curing agents such as dicyandiamide, urea, imidazole, boron trifluoride (BF₃), amine complexes, boron trichloride (BCl₃), and diamines (e.g., Lonzacure®) have been employed as low temperature curing agents and/or catalysts. While some of these curing agents can exhibit relatively good stability at room temperature (e.g., tack life greater than about one week), owing either to latent reactivity or low reactivity, they all exhibit drawbacks. In one aspect, some of these curing agents may tend to lower the mechanical properties of the resultant composite. Alternatively, other curing agents may increase the brittleness of the matrix, which in turn lowers the toughness of the composite. In another example, these curing agents may lower the modulus of the matrix and/or increase the propensity of the matrix to absorb moisture, each of which may reduce the hot and wet mechanical performance of the resultant composite. In another aspect, some of these curing agents may exhibit reactivity which is too great, reducing the out-life (e.g., room temperature working time) of the matrix and prepreg.

### SUMMARY

An embodiment of the present invention represents an epoxy polymer composition containing one or more epoxy resins, a hydrazine-based curing agent in less than 50% stoichiometry based upon the epoxy resins equivalent weight, and an amine curing agent in greater than 30% stoichiometry based upon epoxy equivalent weight.

A further embodiment of the present invention represents a method of forming a polymer composition by the steps of providing one or more epoxy resins, providing a hydrazine-based curing agent in less than 50% stoichiometry based upon the epoxy resins equivalent weight, and providing an amine curing agent in greater than 30% stoichiometry based upon the epoxy resins equivalent weight wherein the epoxy resins, hydrazine-based curing agent, and amine curing agent are combined into a substantially homogeneous mixture.

A further embodiment of the present invention represents a composite adhesive or fill derived from an epoxy polymer composition containing one or more epoxy resins, a hydrazine-based curing agent in less than 50% stoichiometry based upon the epoxy resins equivalent weight, and an amine curing agent in greater than 30% stoichiometry based upon epoxy equivalent weight.

### BRIEF DESCRIPTION OF THE DRAWINGS

FIG. 1 is a block diagram of one embodiment of a method of making curable epoxy polymer composition;

FIG. 2 is a schematic diagram of time-temperature profiles that may be employed with embodiments of the curable epoxy polymer compositions.

FIG. 3A is a plot of initial degree of cure for a first set of epoxy polymer compositions containing a variety of curing agents;

FIG. 3B is a plot of compression after impact strength for a first set of epoxy polymer compositions containing a variety of curing agents;

FIG. 3C is a plot of open hole compression strength for a first set epoxy polymer compositions containing a variety of curing agents;

FIG. 3D is a plot of wet glass transition temperature for a first set epoxy polymer compositions containing a variety of curing agents;

FIG. 4A is a plot of initial degree of cure as a function for a second set of epoxy polymer compositions containing a variety of curing agents;

FIG. 4B is a plot of tack life for a second set of epoxy polymer compositions containing a variety of curing agents;

FIG. 5A is a plot of initial degree of cure as a function of carbodihydrazide (CDH) stoichiometry for an embodiment of an epoxy polymer composition of the present invention;

FIG. 5B is a plot of open hole compression strength as a function of CDH stoichiometry for an embodiment of a epoxy polymer composition of the present invention;

FIG. 5C is a plot of wet glass transition temperature as a function of CDH stoichiometry for an embodiment of a epoxy polymer composition of the present invention;

FIG. 6A is a plot of initial degree of cure as a function of curing temperature and time; and

FIG. 6B is a plot of wet glass transition as a function of curing temperature and time.

### DETAILED DESCRIPTION

The terms “approximately”, “about”, and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

The term “room temperature” as used herein has its ordinary meaning as known to those skilled in the art and may include temperatures within the range of about 16° C. (60° F.) to 32° C. (90° F.).

The term “fiber” as used herein has its ordinary meaning as known to those skilled in the art and may include one or more fibrous materials adapted for the reinforcement of composites. Fibers may take the form of particles, flakes, whiskers, short fibers, continuous fibers, filaments, tows, bundles, sheets, plies, and combinations thereof. Continuous fibers may further adopt any of unidirectional, multi-dimensional (e.g., two- or three-dimensional), non-woven, woven, knitted, stitched, wound, and braided configurations, as well as swirl mat, felt mat, and chopped mat structures. Woven fiber structures may comprise a plurality of woven tows having less than about 1000 filaments, less than about 3000 filaments, less than about 6000 filaments, less than about 12000 filaments, less than about 24000 filaments, less than about 48000 filaments, less than about 56000 filaments, and less than about 125000 filaments. In further embodiments, the tows may be held in position by cross-tow stitches, weft-insertion knitting stitches, or a small amount of resin, such as a thermoplastic or thermoset resin.

The composition of the fibers may be varied, as necessary. Embodiments of the fiber composition may include, but are not limited to, glass, carbon, aramid, quartz, polyethylene, polyester, poly-benzoxazole (PBO), boron, polyamide, and graphite, silicon carbide, silicon nitride, Astroquartz®, Tyranno®, Nextel®, and Nicalon®, and combinations thereof.

The term “consolidation” as used herein has its ordinary meaning as known to those skilled in the art and may include processes in which the resin or matrix resin flows so as to displace void space within and adjacent to the fibers. For example, “consolidation” may include, but is not limited to, flow of matrix into void spaces between and within fibers and prepregs, and the like. “Consolidation” may further take place under the action of one or more of heat, vacuum, and applied pressure.

The term “impregnate” as used herein has its ordinary meaning as known to those skilled in the art and may include the introduction of an uncured resin, uncured polymer composition or uncured matrix resin between or adjacent to one or more fibers. The uncured matrix may take the form of films, powders, liquids, and combinations thereof. Impregnation may be facilitated by the application of one or more of heat, pressure, and solvents.

The term “prepreg” as used herein has its ordinary meaning as known to those skilled in the art and may include sheets or lamina of fibers that have been impregnated with a matrix resin. The matrix resin may also be present in an uncured or partially cured state.

The terms “cure” and “curing” as used herein have their ordinary meaning as known to those skilled in the art and may include polymerizing and/or cross-linking processes. Curing may be performed by processes that include, but are not limited to, heating, exposure to ultraviolet light, and exposure to radiation. In certain embodiments, curing may take place within the matrix resin. Prior to curing, the matrix resin may further comprise one or more compounds that are, at about room temperature, liquid, semi-solid, amorphous solid, crystalline solids, and combinations thereof. In further embodiments, the matrix resin within a prepreg may be partially cured in order to exhibit a selected stickiness or tack. In certain embodiments, consolidation and curing may be performed in a single process.

The terms “layup” and “prepreg layup” as used herein have their ordinary meaning as known to those skilled in the art and may include one or more prepreg layers that are placed adjacent one another. In certain embodiments, the prepreg layers within the layup may be positioned in a selected orientation with respect to one another. For example, prepreg layups may comprise prepreg layers having unidirectional fiber architectures, with the fibers oriented at 0°, 90°, a selected angle θ, and combinations thereof, with respect to the largest dimension of the layup, such as the length. It may be further understood that, in certain embodiments, prepregs having any combination of fiber architectures, such as unidirectional and multi-dimensional, may be combined to form the prepreg layup.

In further embodiments, prepreg layers may optionally be stitched together with a threading material in order to inhibit their relative motion from a selected orientation. Layups may be manufactured by techniques that may include, but are not limited to, hand layup, automated tape layup (ATL), advanced fiber placement (AFP), and filament winding.

Embodiments of the invention present epoxy polymer compositions comprising epoxy resins and a novel curing agent system. The novel curing agent system comprises a first curing agent component and a second curing agent component. The first, hydrazine-based curing agent, includes one or more compounds containing one or more hydrazine functional groups. Hydrazine-based curing agents include hydrazide functional groups and other hydrazine functional groups. However, it may be understood that epoxy curing agent systems comprising compounds including hydrazine functional groups are within the scope of the disclosed embodiments. The second, amine curing agent component, comprises one or more compounds containing one or more amine functional groups. The novel curing agent system of the present invention may be referred herein as a hydrazine-amine curing system.

The hydrazine-amine curing system of the present invention exhibits good reactivity, as characterized by good or sufficient degree of cure, at relatively low temperatures (e.g., less than about 150° C.). In certain embodiments, the hydrazine-amine curing systems may exhibit good reactivity at temperatures less than about 100° C. to about 70° C.

In further embodiments, the epoxy polymer compositions may be heated at higher temperatures, about 20° C. higher or more above the temperature of the initial cure, these compositions exhibit further reaction which promotes additional curing but is not substantially embrittling. The result of this behavior is that composites formed from embodiments of these compositions exhibit good degrees of cure after low temperature curing but also good mechanical properties after elevated temperature curing, referred to herein as post-curing

Beneficially, the enhanced degree of cure afforded by epoxy polymer compositions comprising hydrazine-amine curing systems may enable the use of lower use temperature, lower cost tooling in the formation of polymer composites. Typically, composites are formed at elevated temperatures using a tool or mold in order to impart a selected shape to the composite structure. The tool may typically be separated from the composite part only after the composite has cured sufficiently to maintain its shape, without distortion, absent the support provided by the tool. By lowering the temperature at which the composite achieves a degree of cure sufficient to allow the composite to resist deformation after removal of the tool and post-curing lower temperature tooling can be used. Relatively low curing temperature could also be advantageous for vacuum bag only composite part manufacture.

As discussed in detail below, in addition to enhancing the degree of cure and/or reducing the time to achieve a selected degree of cure, the hydrazine-amine curing systems typically do not adversely impact the mechanical properties of composites in which they are employed. In one aspect, the hydrazine-based curing agents are used in relatively low concentration because they are highly effective as curing agents when used in combination with amine-based curing agents. For example, about 1 wt. % carbohydrazide may provide desired levels of reactivity or degree of cure when combined with an amine-based curing agent such as 3,3′-diaminodiphenylsulfone (DDS).

In a further aspect, epoxy polymer compositions cured with hydrazine-based curing agents in combination with the amine-based curing agents do not absorb as much water as other curing agents, such as dicyandiamide (dicy) used in combination with amine-based curing agents. Because water absorption typically reduces the mechanical properties of polymer composites (e.g., modulus, strength), the ability of these dicy-amine cured epoxy polymers compositions to resist water absorption improves the wet properties of composites in which they are employed. For at least these reasons, the effect of hydrazine-based curing agents in combination with amine-based curing agents on the mechanical properties of composites is substantially negligible or improved compared to composites without the hydrazine-based curing agents or using other curing agent combinations with amine-based curing agents.

Embodiments of epoxy polymer compositions comprising hydrazine-amine curing systems are also substantially stable at about room temperature. As a result, the tack life and/or room temperature out life of epoxy polymer compositions including hydrazine-amine curing systems are relatively long compared to curing agents such as BF₃ amine curing systems.

These properties, taken together, represent a significant improvement over epoxy polymer compositions which employ other combinations of curing agents. For example, as discussed below in the examples, epoxy polymer compositions including amine-based curing agents in combination with other curing agents, such as BF₃, BCl₃, imidazole, dicyandiamide, and urea compounds, are generally more brittle and/or exhibit reduced mechanical properties as compared with epoxy polymer compositions cured using amine-based curing agents in combination with hydrazine-amine curing systems.

Furthermore, while amine-based curing agents have been previously used in combination with urea compounds and hydrazine-based curing agents (e.g., U.S. Pat. Nos. 4,714,648 and 4,956,411) these epoxy polymer compositions are tailored primarily for use after only initial, low temperature curing. The addition of the urea compounds as a curative makes these epoxy polymer compositions extremely reactive at cure cycles of about 130-150° C. for 1 h. However, the mechanical properties of these materials are low, especially under hot/wet conditions. From this, it may be further extrapolated that, after elevated temperature post-curing, composites formed from these compositions would exhibit similarly poor mechanical properties. In contrast, the epoxy polymer compositions disclosed herein exhibit good reactivity at low temperatures and good mechanical properties after both low temperature and elevated temperature cures. These and other advantages of the disclosed embodiments are discussed in detail below.

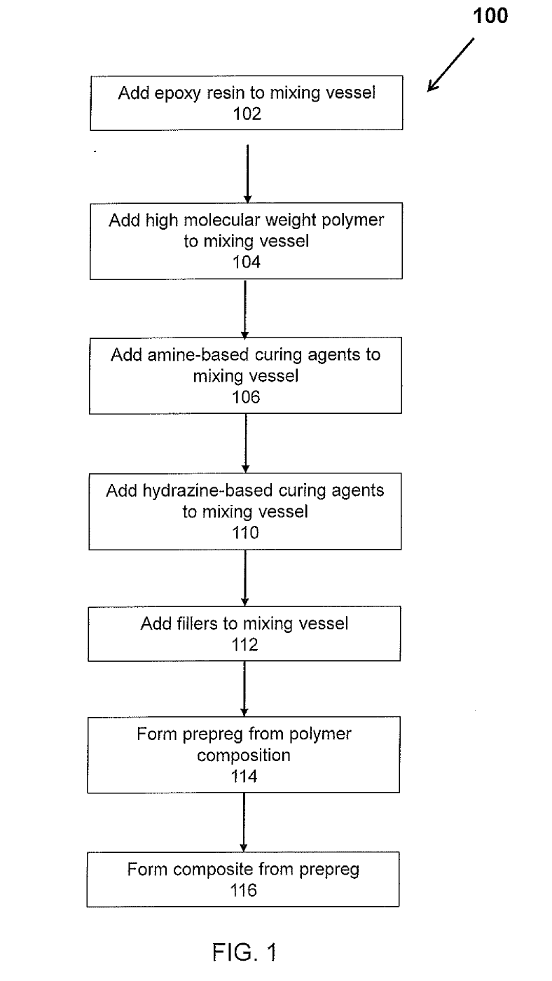

FIG. 1 illustrates one embodiment of a method 100 of manufacturing epoxy polymer compositions of the present invention. Such compositions may be employed for the manufacture of adhesives, surfacing films, prepregs, composites and the like as discussed in greater detail below.

The method includes an operation 102 where one or more epoxy resins are added to a mixing vessel. The method 100 may further include an operation 104 where one or more high molecular weight polymers, for example high molecular weight thermoplastic polymers and/or rubbers are added to the mixing vessel. The high molecular weight polymers may be substantially soluble, substantially insoluble, swellable and/or partially soluble within the epoxy polymer composition. The method 100 may also include an operation 106 where one or more amine-based curing agents are added to the mixing vessel. The method 100 additionally includes an operation 110 where one or more hydrazine-based curing agents are added to the mixing vessel. The method 100 may also include an operation 112 where one or more fillers are added to the mixing vessel. As discussed in detail below, in the method 100, the components of the epoxy polymer composition may be added to a mixing vessel equipped for mixing, heating, and/or cooling the components at any time during preparation of the composition.

As necessary, one or more solvents may also be added to the epoxy polymer composition to promote mixing of the components. Examples of such solvents may include, but are not limited to, acetone, dioxolane, methyl ethyl ketone (MEK), ethyl acetate, alcohols, N-methylpyrrolidone (NMP), chlorinated solvents, and dimethylacetamide. It may be understood that one or more of these components may be omitted or optionally added and that the steps of the method 100 may be performed in any order, as necessary.

As illustrated in FIG. 1, one or more epoxy resins may be added to the mixing vessel in block 102. Non-limiting examples of such epoxy resins are discussed below. Any of these epoxy resins can be used alone or in combination.

In one example, suitable epoxy resins are described in Henry Lee and Kris Neville, Handbook of Epoxy Resins, McGraw-Hill (1967) and in U.S. Pat. Nos. 4,579,885, 4,517,321, and 4,686,250. The entirety of each of these references is hereby incorporated by reference.

Other suitable epoxy resins are commercially available or known in the literature. Examples of such epoxy resins are polyglycidyl compounds, including polyfunctional compounds such as alcohols, phenols, aromatic hydroxyls such as naphthols, carboxylic acids, novalacs, resoles, phenol-formaldehyde novalacs, aromatic amines or aminophenols epoxidized with epichlorohydrin or other methods, and epoxidized dienes or polyenes.

Further examples of epoxy resins include diglycidyl ethers of diene-modified phenolic novolacs, the reaction products of polyfunctional cycloaliphatic carboxylic acids with epichlorohydrin, cycloaliphatic epoxides, cycloaliphatic epoxy ethers and cycloaliphatic epoxy esters, and the like.

Other epoxy resins may comprise tetra-functional, tri-functional, and/or di-functional epoxies in any combination. Examples of tri-functional epoxies include triglycidyl p-aminophenol, triglycidyl m-aminophenol (e.g, MY-0510, MY-0500, or MY-0600—Huntsman). Examples of difunctional epoxy resins which may be used include but are not limited to bisphenol-F epoxies, (e.g., PY306, LY-9703, GY281, and GY-285—Huntsman Corporation or Hexion Specialty Chemicals) and bisphenol-A epoxies (e.g., GY-6010, Epon 828—Hexion Speciality Chemicals and DER 331, DER 661, and DER669—Dow Chemical). Novolac epoxies are also suitable (e.g., DEN 428 and 439—Dow Chemical). An example of a tetrafunctional epoxy is tetraglycidyl diaminodiphenyl methane (e.g., MY-721, MY-720, and MY-9512—Huntsman). Also suitable are Bisphenol S type epoxy resins, brominated epoxy resins, and naphthalene epoxies (Dainippon Ink and Chemicals).

In an embodiment, the epoxy resins may be provided in a concentration of about 10 to 90 wt. % on the basis of the total weight of the polymer composition. In another embodiment, the concentration of the epoxy resins may range between about 30 to 70 wt. % of the polymer composition.

In other embodiments, epoxy resins may be blended with other resin systems. Examples of such other resin systems may include, but are not limited to, resins with maleimide end groups, for example, bismaleimide resins, resins with acetylene end groups, resins with nadic imide end groups, resins with cyanic ester end groups, resins with vinyl end groups, resins with benzoxazine end groups and resins with allyl end groups. The concentration of compatible resins in blends may be up to about 40%.

In block 104, one or more high molecular weight polymers, may be added to the mixing vessel. In certain embodiments, these high molecular weight polymers may comprise thermoplastic or rubber polymers. In one aspect, these polymers may act to modify the uncured epoxy polymer composition and/or provide higher mechanical properties to the cured epoxy polymer composition. In another aspect, these high molecular weight polymers may act to modify other important properties of the uncured and cured composition, for example, viscosity. The high molecular weight polymers, in certain embodiments, may possess reactive groups positioned on the ends or distributed along the main chain or side chains. Examples of reactive groups include, but are not limited to, epoxies, amines, amides, alcohols, phenols, olefins, benzoxazines, naphthols, maleimides, cyanates and aromatic hydroxyls.

In a certain embodiment, the high molecular weight polymers may be substantially soluble, substantially insoluble, swellable and/or partially soluble in the cured and/or uncured epoxy polymer composition.

The high molecular weight polymers may improve the handling characteristics of the prepreg, adhesive or film made from the epoxy polymer composition before cure. They may further improve the toughness or other properties of the cured epoxy polymer composition. The high molecular weight polymers may be provided in a concentration ranging between about 0 to 40 wt. %. In a preferred embodiment, the thermoplastic and/or rubber polymers may be provided in a concentration ranging between about 5 to 30 wt. %.

Examples of substantially soluble, substantially insoluble, swellable and partially soluble high molecular weight polymers may include compounds having in the main chain any combination of bonds including but not limited to carbon-carbon bonds, amide bonds, imide bonds, ester bonds, ether bonds, carbonate bonds, urethane bonds, urea bonds, thioether bonds, sulfone bonds, imidazone bonds, and carbonyl bonds. Other suitable compounds comprise block co-polymer type polymers which may be rubbers, thermoplastics or rubber-thermoplastic combinations.

Examples of these compounds include, but are not limited to, vinylic resins (e.g., polyacrylate, poly(vinyl acetates), polystyrols, polyamides, phenoxys, polyacetals, polyaramids, polyesters, polycarbonates (e.g., Lexan®), poly(phenylene oxides), poly(phenylene sulfide), polyallylates, polybenzimidazoles, polyimides (e.g., Kapton®, Uplex®), polyamideimides, polysulfones (e.g., Udel®), polyethersulfones, polyether ether ketone (PEEK), polyether ketone ketone (PEKK), polyether imides (e.g., Ultem®), polyaramid, polybenzimidazole, hydrocarbon resins (e.g., polyethylene, polypropylene), and cellulose derivatives (e.g., cellulose acetate and cellulose lactate), and styrene-butadiene block co-polymers.

Examples of rubber compounds may include, but are not limited to, carboxy terminated butadieneacrylonitrile (CTBN), amine terminated butadieneacrylonitrile, fluorocarbon elastomers, silicone elastomers, Dumond® rubber particles (Zeon Chemicals), acrylic particles, core-shell particles, Paraloid® particles (Rhom and Hass), Metablen® particles (Mitsubishi Rayon), styrene-butadiene polymers, and Blendix® particles (Warner Co., Ltd.).

In certain embodiments, the temperature at which the high molecular eight polymers and epoxy resins are added may be adjusted in order to facilitate dissolution of any soluble thermoplastic or rubber within the epoxy resins. After the soluble component is substantially dissolved, the composition may be further cooled to inhibit premature reaction of curing agents which have been, or will be, added to the polymer composition.

The high molecular weight polymers may further comprise fine particles. The fine particles can comprise rubbers, thermoplastics, or thermoset resins as described above or any combination or blends, thermoplastic blends, and thermoset blends. Examples of such particles are described in U.S. Pat. Nos. 5,028,478, 5,242,748, 5,605,745, and 5,266,610. The fine particles may also comprise rubber particles, including, but not limited to, those described in U.S. Pat. Nos. 4,779,215, 4,779,218, and 5,464,902. Each of these patents is incorporated by reference in their entirety.

The diameter of the fine particles may also be varied. The average diameter of the particles can be varied and this can determine the location of the particles in the final composite. Particles less than about 1μ to 20μ tend to be at the ply interface and particles greater than about 1μ to 20μ tend to be more uniformly distributed.

In block 106, one or more amine-based curing agents may be added to the mixing vessel. In an embodiment, the amine-based curing agents may be provided in a combined concentration that is greater than about 30% stoichiometry, based upon the epoxy equivalent weight. For example, the amine-based curing agents may be used in stoichiometry of about 30 to 150%. In further embodiments, the amine-based curing agents may be liquid, semi-solid, amorphous solid, crystalline solids, and combinations thereof.

The amine-based curing agents may include, but are not limited to, amines, diamines, and polyamines, used alone or in combination. Non-limiting examples of suitable amines, diamines, and polyamines may be found in Henry Lee and Kris Neville, Handbook of Epoxy Resins, McGraw-Hill (1967). Suitable examples include but are not limited to 4,4′-diaminodiphenyl ether, 4,4′-diaminodiphenyl methane, 4,4′-diaminodiphenyl sulfone (4,4′-DDS), 3,3′-diaminodiphenyl sulfone (3,3′-DDS), p-phenylene diamine, m-phenylene diamine, 4,4′-bis(aminodiphenyl) propane, 4,4′-diaminodiphenyl sulfide, trimethylene glycol bis(p-aminobenzoate) and the like, as well as their various position isomers. Examples of aromatic-aliphatic diamines or polyamines include glycol-bis(p-aminobenzoate). Further examples of aromatic and polynuclear aromatic diamines include but are not limited to those discussed for example in U.S. Pat. Nos. 4,579,885, 4,517,321, and 4,686,250, the entirety of each of which are hereby incorporated by reference, as well as xylylene diamine, bis(aminomethyl)cyclohexane, and the like, various Lonzacure® are suitable, for example, M-MIPA and 4,4′-methylenebis(2,6-diisopropylaniline) (e.g., Lonzacure M-DIPA—Lonza Corp.). Additional examples of amine-based curing agents may include, but are not limited to, 9,9-bis(3-chloro-4-aminophenyl)fluorine (CAF), aniline, 4,4′-diaminobenzophenone, 2,2-Bis [4-(4-aminophenoxy)phenyl] propane (BAPP), sulfanilamides, aminobenzamides, tetramethylguanidine, and dicyandiamide (dicy).

In certain embodiments, the amine-based curing agents may not comprise ureas. As discussed below in the examples, it has been observed that urea-based curing agents in combination with hydrazine-based curing agents with amine-based curing agents are highly reactive and yield cured epoxy polymer compositions with poor mechanical properties.

In block 110, one or more hydrazine-based curing agents can be added to the mixing vessel. In further embodiment, hydrazine-based curing agents may be crystalline solids, amorphous solid, semi-solid, or liquid and combinations thereof. The hydrazine-based curing agents may comprise one or more compounds containing hydrazine functional groups and derivatives thereof. The hydrazine-based curing agents may be provided in a concentration that is less than about 50% stoichiometry, based upon the epoxy resins equivalent weight.

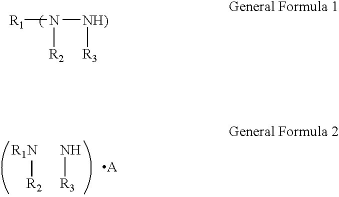

In an embodiment of the present invention, suitable hydrazine-based curing agents are given by General Formulas 1 and 2. These Formulas depict a number of hydrazine chemical compounds including the hydrazides used in the examples. One, or more than one, of the hydrazine-based curing agents can be used with one or more of the suitable amine-based curing agents discussed above to make the hydrazine-amine curing system of this invention.

R₁, R₂ and R₃ denote a hydrogen (hydrogen includes deuterium throughout this disclosure) or a substituent, and they can be varied independently. A substituent can be bonded through a carbon, a nitrogen, a oxygen, a sulfur, a phosphorus or a boron atom. It can contain carbon, nitrogen, oxygen, sulfur, hydrogen, boron, silicon, sulfur, phosphorus and/or halogen bonded in any arrangement. If R₁, R₂ or R₃ is substituent, it can have further hydrazine functionality.

The following examples are illustrative and are in no way limiting of the suitable hydrazine-based curing agents. Examples are phenylhydrazine, naphthalene hydrazine, 1-hexylhydrazine, p-phenylenebis(hydrazine), 1,6-hexamethylene dihydrazine, and 1,2-diphenyl hydrazine. The hydrazine-based curing agent may also contain both hydrazines and hydrazides, for example, 3-hydrazinylbenzoic acid hydrazide.

The hydrazine can also be a hydrazide. Non-limiting examples are carbohydrazide (CBH), isophthalic dihydrazide (IDH), phthalic dihydrazide, terephthalic dihydrazide, adipic dihydrazide (ADH), 1,2,3-benzenetricarboxic trihydrazide, aromantic monohydarzides, benzoic acid hydrazide, aliphatic monohydrazides, aliphatic dihydrazides (e.g., Adjicure VDH (Ajinomoto Co. Inc), Adjicure LDH (Ajinomoto Co. Inc), sebaic acid dihyrazide, aliphatic trihydrazides, aliphatic tetrahydrazides, and aromatic monohydrazides, aromatic dihydrazides, aromatic trihydrazides, aromatic tetrahydrazides.

In further embodiments, the hydrazine may contain one or more sulfur or phosphorus based groups directly attached to the hydrazine. Non-limiting examples are p-toluenesulfonylhydrazide, benzenesulifinic hydarzide, sulfuryl hydrazide, and phosphoric acid trihydrazide.

In another embodiment, the hydrizine may contain one or more amine groups. Non-limiting examples are 2-aminobenzoic hydrazide or 4-aminobenzoic hydrazide.

The stoichiometry of hydrazine-based curing agents may be determined as follows. The amine equivalent weight used in stoichiometry calculations is calculated as follows for the hydrazine-based curing agents. The hydrogen (or deuterium) on all nitrogens are counted as active hydrogens except those on a nitrogen directly attached to a carbonyl, a sulfur or a phosphorus. An example of the calculation is benzoic acid hydrazide where the benzoic substituent is R₁ and R₂ and R₃ are hydrogens in General Formula 1. Therefore, R₁ contains a carbonyl directly attached to a nitrogen so the R₂ hydrogen is not counted as an active hydrogen but the two hydrogens on the other nitrogen are counted. Therefore, there are two active hydrogens per molecule and the amine equivalent weight is molecular weight (MW) divided by two. In this case the 168 grams/mole MW is divided by two giving an amine equivalent weight of 68 grams/equivalent. Another example is carbohydrazide where there are two active hydrogens per hydrazine since the hydrogen next to the carbonyl in not counted. This gives four active hydrogens per molecule, and the amine equivalent weight is MW/4. If the molecule is p-toluenesulfonylhydrazide the number of active hydrogens is 2 and the amine equivalent weight is MW/2. If the molecule is phenyl hydrazine there are 3 active hydrogens in this case all are counted and the amine equivalent weight is the MW/3.

In further embodiments, a hydrazine salt can also be used as the hydrazine-based curing agent given by General Formula 2. The above discussion for General Formula 1 applies to General Formula 2 with regard to substituents and calculation of amine equivalent weight. The difference is that the hydrazine has additionally an ionic salt structure afforded by an acid group shown as A in General Formula 2. The acid group, A, can be inorganic acid, non-limiting examples are hydrochloric, phosphoric, carbonic or sulfuric. The acid group, A, can be carboxylic acids. Non-limiting examples are acetic, benzoic or terephthalic. The acid group, A, can be a Lewis acids such as borontrifluoride. Further non-limiting examples of suitable hydrazide salts are hydrazinium benzoate, hydrazinium chloride, hydrazinium difluoride.

In block 112, one or more functional additives may be added to the mixing vessel. The functional additives may be provided to influence one or more of mechanical, rheological, electrical, optical, chemical, flame resistance and/or thermal properties of the cured or uncured epoxy polymer composition. Such additives may further comprise materials that chemically react with the epoxy resin or are unreactive with the epoxy resin. The size distribution and geometry of such additives may also be varied, as necessary. For example, the size of the additives may range between nanoscale dimensions (approximately 1 nm to 100 nm), microscale dimensions (approximately 100 nm-100 μm), and macroscale dimensions, greater than about 100 μm. In other examples, the additives may be configured in geometries including, but not limited to, particles, flakes, rods, and the like. Examples of additives may include, but are not limited to, organic and inorganic substances such as flame retardants, ultraviolet (UV) protectors, thickeners (e.g., Cabosil®), glass or ceramic balloons or balls, and reinforcements to enhance one or more of strength, damage tolerance, toughness, or wear resistance (e.g., ceramics, and/or glasses) of the uncured or cured resin composition or composite part. The fillers may be added to the epoxy polymer composition in a concentration ranging between about 0 to 40 wt. %.

In certain embodiments, the epoxy polymer composition may be used as an adhesive with or without carriers. If used as an adhesive, the composition would be brought into contact with the adherents and cured. Curing of the adhesive may be performed as a secondary process or co-cured with prepregs as part of a prepreg curing, composite manufacturing process.

Non-limiting examples of adhesive carriers may include a variety of thermoplastic polymer fibers, carbon fiber, metallic screens or foils, non-woven mats, random mats, knit carriers, metal coated carbon veils, and the like. The geometry of the carrier may be varied, as necessary. For example, the thickness of the carriers may range between about 0.5 to 5 mil. Other parameters regarding the carrier, such as number of openings per unit area, strand width, and patterning may also be varied, as necessary.

Examples of metallic screens or foils may include expanded metallic screens or foils, and metal coated veils. Such screens and foils may comprise copper, aluminum, silver, nickel, and alloys thereof.

Examples of non-woven mat, woven or knit carriers may include carbon mats, polymer mats, and metal coated carbon, glass, or polymer glass veils. The non-woven mat, woven or knit carriers may be coated with copper, aluminum, silver, nickel, and alloys, and alloys thereof.

The epoxy polymer composition may also be used as a surfacing ply. In certain embodiments, the epoxy polymer composition may be coated as a film using a hot-melt coating or solvated film coating processes. Embodiments of the surfacing film may be further applied to a supporting structure, including carriers, as discussed above.

In other embodiments the epoxy polymer composition may be further employed to form prepregs. Prepregs may be fabricated by impregnation of the composition into fibers, with or without application of heat and/or pressure. The impregnation may be performed using a number of techniques known in the art including, but not limited to, solution processes such as solution dip and solution spray, melt and working processes such as direct melt and film calendaring.

The relative proportions of fiber and matrix within the prepreg may be varied, as dictated by the intended application. In one embodiment for composite applications, the weight fraction of fiber present within the prepreg may range between about 20 to 80 wt. %, and more preferably between 50-75% on the basis of the total weight of the prepreg. In another embodiment, the epoxy polymer composition may be present in the prepreg in an amount ranging between approximately 20 to 80 wt. %, and in another embodiment, between about 25-50% based upon the total weight of the prepreg.

One or more solvents may be further added to the epoxy polymer composition in order to reduce its viscosity, facilitating impregnation and handling of the prepreg. Examples of such solvents may include, but are not limited to, acetone, dioxolane, MEK, ethyl acetate, alcohols, N-methylpyrrolidone (NMP), chlorinated solvents and dimethylacetamide. In certain embodiments, the solvent may be present within the prepreg in a concentration ranging from about 0 to 5 wt. %, based upon the total weight of the prepreg.

The prepregs so formed may be further treated with tackifiers or tougheners by sprinkling, spraying or applying a film to the surface.

Prepregs so formed may be further employed to form composite structures in block 116. In an embodiment, the prepregs may be plied or stacked into a prepreg layup and subjected to one or more of heat, pressure, and vacuum in order to consolidate and cure the layup into the composite structure. Consolidation and curing may be performed in an enclosure capable of providing one or more of heat, pressure, and/or vacuum, such as ovens and autoclaves. The prepreg layup may be further placed within a substantially gas-tight, vacuum envelope.

Vacuum may be applied to the prepreg layup by a vacuum source in communication with the enclosure and/or vacuum envelope. The applied vacuum may further be varied or kept constant.

In further embodiments, the enclosure may be capable of applying and/or supporting a pressure. The applied pressure may be provided by a pressure source in communication with the enclosure. The applied pressure may be varied or kept constant. For example, a pressure ranging about atmospheric pressure up to 3000 psi may be applied.

Heat may be further applied to the prepreg layup to facilitate consolidation and curing. In one aspect, elevated temperatures may reduce the viscosity of the polymer composition, allowing the composition to enter and displace void space from the prepreg layup.

In other aspects, the prepreg layup may be heated in order to cure the uncured or partially cured epoxy polymer composition. The exact cure schedule and conditions will vary somewhat depending on the amine-based curing agents, the hydrazine-based curing agents, and the epoxies selected. As discussed above, the epoxy polymer composition substantially reacts, gels or cures, at relatively low temperatures and times, about 70 to 150° C., for example, at or below about 121° C. for between about 0.5 to 24 h. In further embodiments, the epoxy polymer composition may be substantially cured at temperatures ranging between about 70 to 120° C. for between about 0.5 to 24 hours. For example, embodiments of the composition may achieve degrees of cure greater than about 40% under these conditions, reaching upwards of about 95%. In another embodiment, substantially complete curing may be achieved by post-curing at higher temperatures of about 120 to 200° C. for between about 0.5 to 24 h.

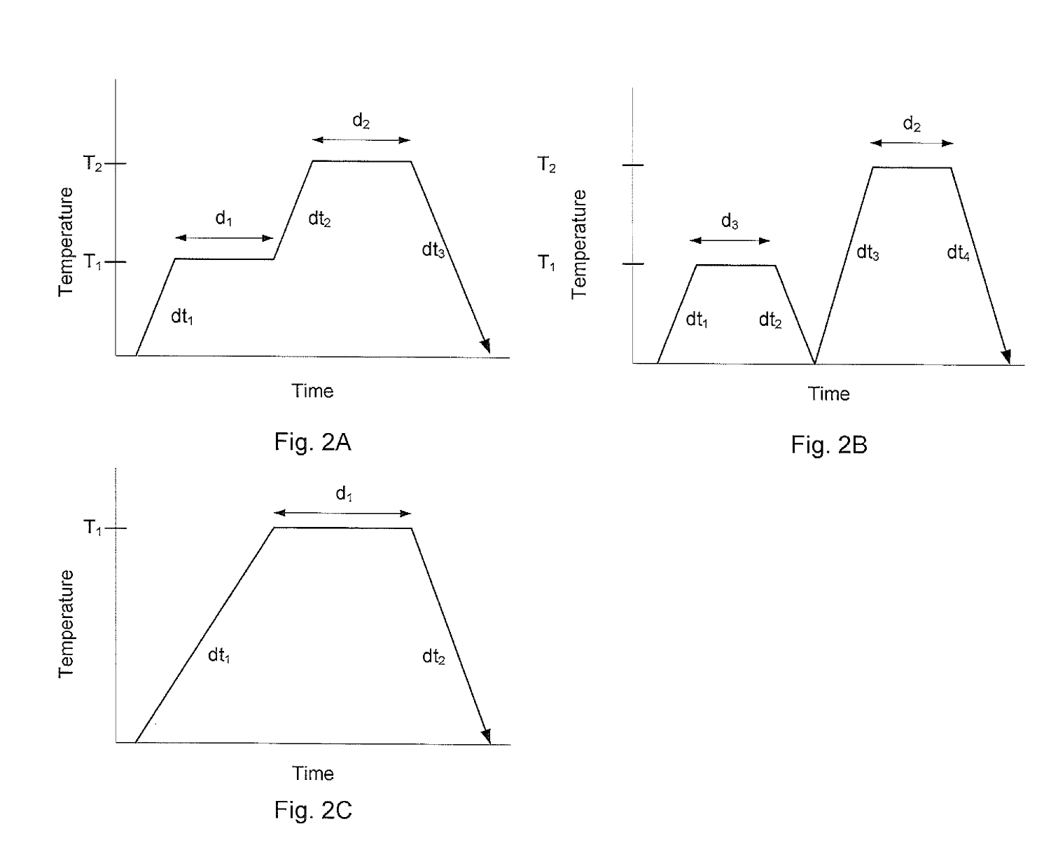

The heat treatment schedule for curing embodiments of the epoxy polymer composition may be varied depending on the epoxies, curing agents, fiber and structure. For example, as illustrated in FIG. 2A, the prepreg layup of the polymer composition may be heated at a selected rate, dt₁ to a temperature, T₁, and held at this temperature for a duration, d₁ in order to provide an initial, cure. The prepreg layup of polymer composition may be further heated at a selected rate, dt₂ to temperature, T₂, held at this temperature for a second duration, d₂, and cooled at rate, dt₃ to about room temperature.

In another example, illustrated in FIG. 2B, the prepreg layup of the epoxy polymer composition may be heated at a first rate, dt₁ to a temperature, T₁, and held at this temperature for a duration, d₃ in order to provide an initial cure. The initially cured prepreg layup may be subsequently cooled to about room temperature at a second rate, dt₂, then unbagged and a free standing post-cure may be conducted. The initially cured layup may be further heated at a rate, dt₃ to temperature, T₂, held at this temperature for duration, d₂, and cooled at rate, dt₄, in order to conduct the post-cure.

In a further example, illustrated in FIG. 2C, the prepreg of the epoxy polymer composition may be heated at rate, dt₁, from about room temperature to temperature, T₁, held at this temperature for duration, d₁, and cooled back to about room temperature at rate dt₂.

In certain embodiments, the durations d₁-d₃ may range between about 0.5 to 24 hrs. In alternative embodiments, the ramp rates dt₁-dt₄ may range between about 0.1 to 10° C./minute.

In further embodiments, one or more of the hold temperatures and times may be replaced by ramps that are sufficiently slow or designed to achieve the desired degree of cure. In one embodiment, the prepreg layup of the epoxy polymer composition can be ramped at about 0.01 C/minute to 2° C./minute.

During the consolidation and/or curing processes, the prepreg layup may be further placed in contact with a mold or tool. The mold may be configured with a selected shape and may further comprise texture and/or other surface and through thickness features, as necessary. The prepreg layup may be placed in contact with at least a portion of the mold such that the composite may be cured in the shape of the mold. Beneficially, the ability to cure the epoxy polymer composition at relatively low temperatures enables the use of molds that are manufactured from relatively inexpensive, materials that are capable of operating at low to moderate temperatures, rather than more expensive materials capable of operating at relatively high temperatures.

In other embodiments, transfer molding, such as resin transfer molding (RTM) and vacuum assisted resin transfer molding (VARTM) may be employed to form composites. In RTM and VARTM, the epoxy polymer composition is injected into a mold or mold that contains the fibers, as discussed in Chapter 9 of “Manufacturing Processes for Advanced Composites” F. C. Campbell, Elsevier, 2004. The fibers are provided as a dry fiber preform or a pre-impregnated preform with less than the desired amount of the epoxy polymer composition. The composition is then introduced into the mold with or without a carrier solvent. Under the influence of gravity, vacuum, pressure, and capillary action (RTM) or gravity, capillary action, and vacuum (VARTM), the composition enters the fibers and is cured.

In further embodiments, resin film infusion (RFI) may be employed to fabricate composite parts employing embodiments of the composition. The Campbell reference also discusses this technique in Chapter 9. A epoxy polymer composition of the invention can be introduced into the dry fiber performs as a thick film or partially impregnated using either vacuum only or pressure and vacuum.

In additional embodiments, the prepreg of the invention may be used to co-cure over core. For example the prepreg may be used with an adhesive of the invention or a suitable adhesive not of the invention. In an embodiment, co-curing the prepreg of the composition over core may be performed as discussed in the Campbell reference, Chapter 8.

In additional embodiments, the core material used with the prepreg can be honeycomb, foam, syntactic foam or the like. Typical honeycomb core sandwich panels are described in U.S. Pat. Nos. 5,284,702; 4,622,091; and 4,353,947, which we incorporate by reference. Additionally, cores can range in cell size, density, open celled or close celled, and material type.

The following non-limiting examples are illustrative of the present invention and are not to be construed as to limiting the scope thereof in any manner.

### EXAMPLES

Although the following examples show, describe, and point out the fundamental novel features of the present teachings, it will be understood that various omissions, substitutions, changes, and/or additions in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

The mechanical performance of composites formed from epoxy polymer compositions comprising the novel, hydrazine-amine curing systems of the present disclosure are discussed in comparison with other curing agents. The performance of each curing agent system was characterized by evaluation of epoxy polymer compositions and prepregs and composites formed therefrom.

Mechanical testing of composites used tests well known in the art which included one or more of compression after impact (CAI) tests, open hole compression (OHC) tests, glass transition temperature evaluation under wet conditions, referred to as T_{g}-wet, degree of initial cure, and tack life. As discussed in detail below, composites having matrices comprising an epoxy, a hydrazine-based curing agent, and a non-urea, amine-based curing agent exhibited an improved balance of mechanical properties, as opposed to other curing agents, particularly hydrazine-based curing agents combined with urea. It may be understood that these examples are discussed for illustrative purposes and should not be construed to limit the scope of the disclosed embodiments.

### Example 1

### Composite Mechanical Performance of Hydrazine and Non-Hydrazine Epoxy Polymer Compositions

The mechanical performance of composites formed from epoxy polymer compositions comprising the novel hydrazide-amine curing systems agents of the present invention and curing agents or catalysts in combination with 3,3′-diamino diphenylsulfone (3,3′-DDS) not of the invention were compared.

Nine epoxy polymer compositions were evaluated in composites. Compositions 1-5 included 3,3′-DDS and one of BF₃, BCl₃, an imidazole, urea compound, and dicyandiamide, respectively, as curing agents. The BF₃ comprised Anchor 1115 (Air Products), a liquid BF₃ complexed with benzyl amine and isopropyl amine. The BCl₃ comprised DY9577 or GY6010/BCl₃ amine complex (Huntsman Advanced Materials). The imidazole comprised 1-cyanoethyl-2-theyl-4-methyl-imidazole (Curamid CN, Poly Organix). The urea compound comprised toluene bisdimethyl urea (CA-150, Cytec Industries), and the dicyandiamide comprised Amicure CG-1400 (Air Products).

The compositions of trials 6 and 7 employed 3,3′-DDS, urea (CA-150), and isophthalic dihydrazide (IDH) or carbodihydrazide (CDH), respectively, as curing agents. IDH was obtained from A&C Catalyst and CDH was obtained from Japan Finechem Company Inc.

The composition of trials 8-9 represents an embodiment of the dual cure hydrazine-amine curing system of the present invention and employed 3,3′-DDS and CDH or IDH as curing agents.

Each of the epoxy polymer compositions evaluated in this example contained two epoxy resins and a substantially soluble thermoplastic polymer. The epoxy resins comprised a tetra-functional epoxy, tetraglycidyl diamino diphenylmethane (MY721, epoxy equivalent weight (EEW) about 112; Huntsman Advanced Materials) and a tri-functional epoxy, 4-glycidyloxy-N,N-Diglycidylaniline (MY0510, EEW about 101; Huntsman Advanced Materials). The high molecular weight polymer, a soluble thermoplastic toughening agent, comprised a functionalized polyether sulfone, KM180 (Cytec Engineered Materials).

Each of these compositions are illustrated below in Table 1:

TABLE 1
Epoxy Polymer Compositions of Example 1

| | Concentration (wt. %) or Stoichiometry (%) | | | | | | | | |
|---|---|---|---|---|---|---|---|---|---|
| Component | Trial 1 | Trial 2 | Trial 3 | Trial 4 | Trial 5 | Trial 6 | Trial 7 | Trial 8 | Trial 9 |
| MY721 conc. | 25.88 | 25.23 | 26.11 | 25.55 | 25.23 | 26.65 | 37 | 25.88 | 25.52 |
| MY0510 conc. | 25.88 | 25.23 | 26.11 | 25.55 | 25.23 | 26.65 | 37 | 25.88 | 25.52 |
| KM180 conc. | 20 | 20 | 20 | 20 | 20 | 20 | 20 | 20 | 20 |
| 3,3′-DDS conc. | 27.24 | 26.54 | 27.48 | 26.9 | 26.54 | 18.7 | | 27.24 | 26.86 |
| 3,3′-DDS stoich. | 90% | 90% | 90% | 90% | 90% | 60% | | 90% | 90% |
| BF₃ conc. | 1 | | | | | | | | |
| BCl₃ conc | | 3 | | | | | | | |
| Curamid CN | | | 0.3 | | | | | | |
| (Imidazole) | | | | | | | | | |
| Amicure CG- | | | | 2 | | | | | |
| 1400 | | | | | | | | | |
| (Dicyandiamide) | | | | | | | | | |
| CA-150 (Urea) | | | | | 3 | 4 | 3 | | |
| IDH conc | | | | | | 4 | | | 2.10 |
| IDH stoich | | | | | | 16% | | | 9% |
| CDH conc | | | | | | | 3 | 1 | |
| CDH stoich | | | | | | | 19% | 9% | |

Approximately 2400 g batches of each epoxy polymer composition were fabricated as follows. MY721 and MY0510 epoxy resins were added to a mixing vessel. The mixing vessel was then placed into an oil bath at a temperature of about 70° C. and mixing was begun. Next, the KM180 thermoplastic was added to the resin mixture. The oil bath temperature was increased to about 116° C. in order to allow the KM180 to dissolve into the resin, followed by cooling to approximately 71° C. Subsequently, 3,3′-DDS, at the specified stoichiometric level was mixed into the resin. The remaining curing agent(s) were then mixed into the resin. The epoxy polymer composition was then poured out of the mixing vessel and allowed to cool.

The compositions so fabricated were filmed and made into prepregs comprising a polyacrylonitrile (PAN)-based fiber, IM7 (Tensile Strength of approximately 800 ksi, Tensile Modulus of about 40 MPSI, Hexcel), having an areal fiber weight of about 145 g/m² and a resin content of approximately 33 wt %.

Carbon fiber/epoxy composites were made from these prepregs by laying up the prepreg in a selected orientation and size to the specifications of each test. The prepreg layups were tooled and then cured in an autoclave to form the final composite structure. The prepreg layups were initially cured by heating at a rate of about 0.55° C./min to approximately 93° C. and held at about 93° C. for about 16 hrs under a vacuum envelope with an applied pressure of about 100 psi.

After this initial cure, the degree of cure was evaluated by differential scanning calorimetry (DSC), as discussed below. A free standing post-cure was then completed by heating the composites in an oven, without vacuum or pressure, at about 1.7° C./min to a temperature of about 176° C. and held at about 176° C. for approximately 6 hrs.

### (a) Initial Degree of Cure

Degree of cure was measured by DSC in accordance with ASTM 3418, “Standard Test Method for Transition Temperatures and Enthalpies of Fusion and Crystallization of Polymers by Differential Scanning Calorimetry”. The DSC test was performed on an uncured prepreg sample and a reference sample that was heated to an initial curing temperature for a selected hold time period (e.g., about 93° C. for about 16 hours). Degree of cure was calculated by measuring the heat of reaction of the uncured prepreg and reference sample after the hold time. The difference of the heats of reaction divided by the heat of reaction of the uncured prepreg was taken to be the percent degree of cure.

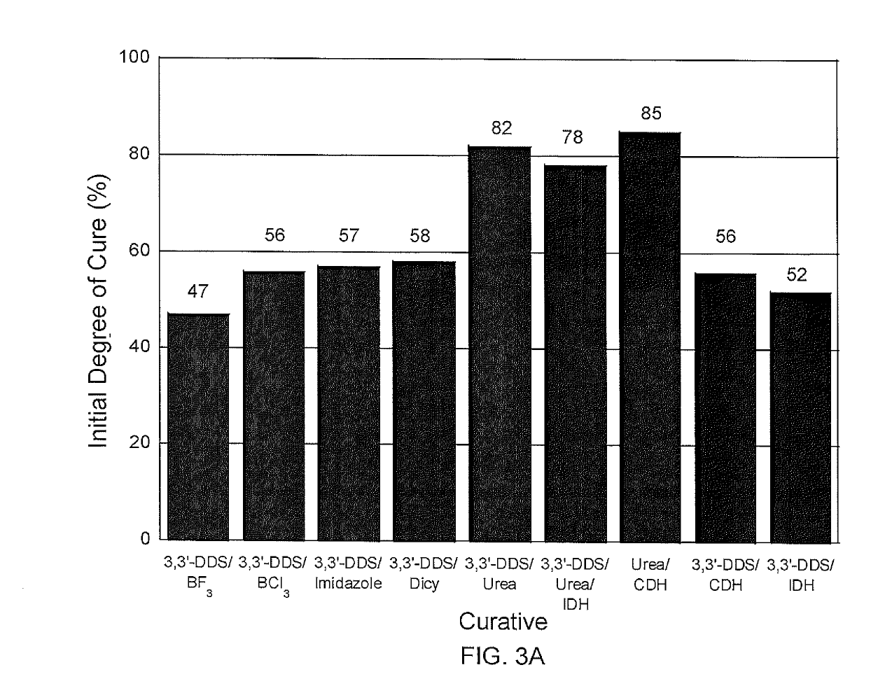

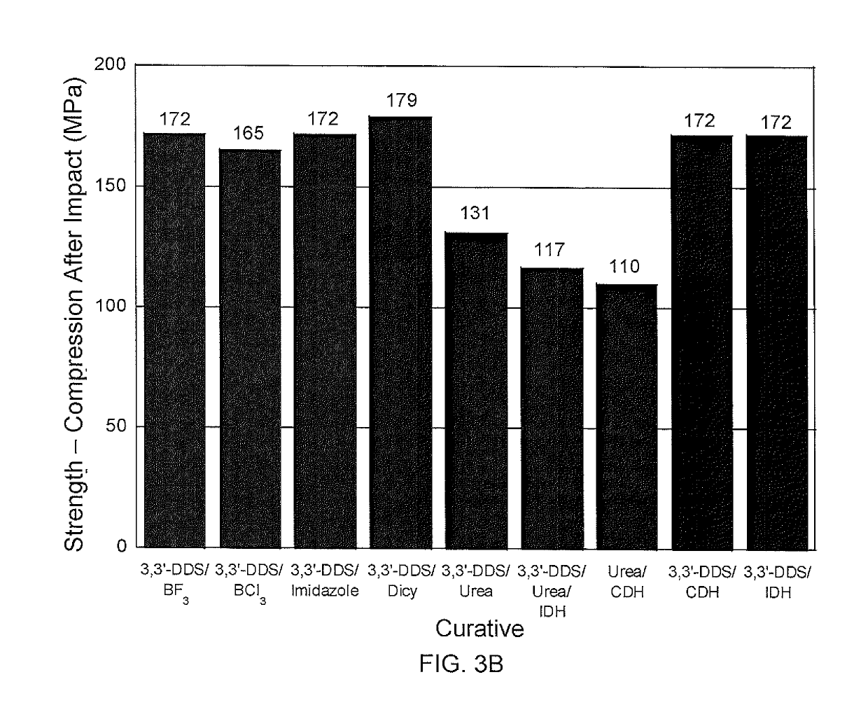

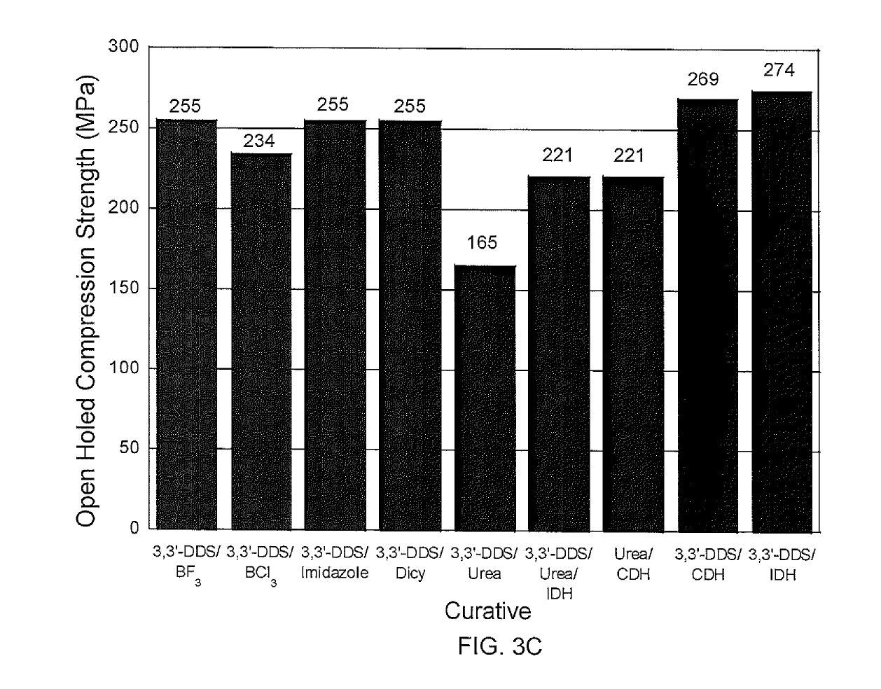

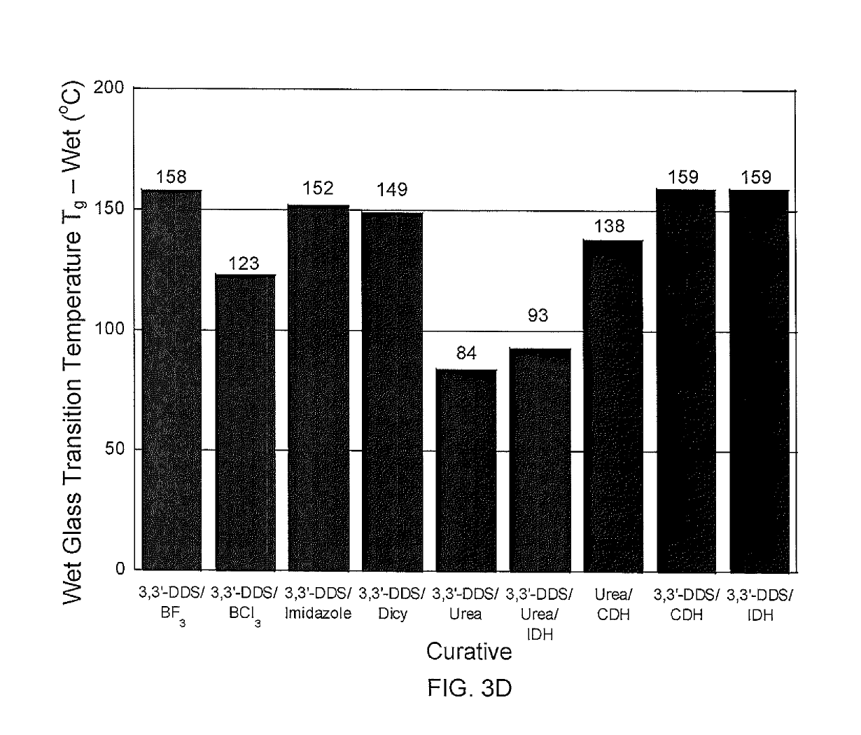

FIG. 3A illustrates the degree of cure obtained for Compositions 1-9. It may be observed that the values of degree of cure varied from about 47 to 85%. The composition containing 3,3′-DDS in combination with BF₃ exhibited the lowest degree of cure. The compositions containing 3,3′-DDS and BCl₃, the imidazole, dicy, CDH and IDH each exhibited comparable degrees of cure which were in about the mid-50s. The compositions containing 3,3′-DDS and CA-150 (urea), CA-150 (urea) and IDH, and CA-150 (urea) and CDH exhibited degrees of cure ranging between about 78-85%.

These results highlight the fact that curatives containing urea compounds are highly reactive at low temperatures. Detrimentally, though, as will be seen below, this curing agent embrittles the cured epoxy polymer composition and adversely impacts the mechanical properties especially composite mechanical properties. The results further highlight the exceptional degree of cure afforded by the hydrazine-amine curing system.

(b) Compression after Impact (CAI) Strength

CAI testing was performed in accordance with the SRMO2 test method (Suppliers of Advanced Materials Association [SACMA], Recommended Methods) with an impact energy of 1500 in-lbs/in and the results are given in FIG. 3B. The ply orientation of these test panels were approximately [+45,0,−45,90]₄ₛ.

The measured CAI strengths ranged from about 110 to 170 MPa. Notably, it may be observed that the composites made from compositions containing urea type components exhibited the lowest CAI strengths, with the composition containing 3,3′-DDS and CA-150 (urea) exhibiting CAI strength of about 131 MPa and the compositions containing 3,3′-DDS, CA-150 (urea), and IDH or CA-150 (urea) and CDH even lower at about 110 to 117 MPa CAI strength. These results show that urea type components give significant embrittlement of the cured epoxy polymer composition, which lowers the damage tolerance and resultant strength of the composite.

In contrast, the composites of the compositions containing 3,3′-DDS and BF₃, BCl₃, the imidazole, dicy, CDH, and IDH each exhibited comparable strengths, ranging between about 165 to 179 MPa CAI strength.

### (c) Open Hole Compression (OHC) Strength

OHC testing was conducted in accordance with ASTM D6484, “Standard Test Method for Open Hole Compressive Strength of Polymer Matrix Composite Laminates”. The ply orientation of these panels were approximately [+45, 0, −45, 90]₃ₛ.

In order to probe the hot and wet performance of the composites, OHC samples were tested at a temperature of about 104° C., after a wet conditioning preparation. The performance of the composite under hot and wet conditions is useful in providing a lower bound on the performance of the composite, as strength and modulus of the composite matrix tend to decrease after exposure to water and at elevated temperatures, which in turn reduces the strength and modulus of the composite itself. The wet conditioning was accomplished by submerging the test coupons in boiling water at approximately 100° C. for approximately 48 hrs.

The measured OHC strengths ranged from about 165 to 274 MPa. As noted above with respect to the open hole compression strength, composites of the urea type component containing compositions exhibited the lowest strengths once again. The composition containing 3,3′-DDS and CA-150 (urea) was the lowest, exhibiting a strength of about 165 MPa, while and the compositions containing 3,3′-DDS, CA-150 (urea), and IDH or CA-150 (urea) and CDH were at about 221 MPa.

In contrast, the composites of the compositions containing 3,3′-DDS and BF₃, BCl₃, imidazole, dicy, CDH and IDH each exhibited OHC strengths which were higher than the CA-150 (urea) containing compositions, ranging between about 234 to 274 MPa. Furthermore, the composites of the CDH and IDH compositions exhibited the highest strength of all the composites tested, about 269-274 MPa, which was about 20 to 60% higher than that of the CA-150 (urea) containing composite compositions and also higher than the other curing agents and catalysts examined.

(d) Glass Transition Temperature-Wet (T_{g}-wet)

T_{g}-Wet testing was conducted in accordance with the SACMA SRM 18R-94 (AP-0123) test method, which is a 3-pt bend method which employs the tangent method of the storage modulus. Measurements were acquired through dynamic mechanical analysis DMA instrument (TA Instruments Model Q800, New Castle, Del.). Samples were wet conditioned prior to testing as discussed above and had a size of about 13×65×2.5 mm.

The measured wet glass transition temperatures of samples conditioned as discussed above ranged from about 84 to 159° C. As noted above with respect to the open hole compression strength and compression after impact testing, the composites of the CA-150 (urea) containing compositions were amongst the worst performing materials. The composites of the compositions containing 3,3′-DDS and CA-150 (urea) and 3,3′-DDS, CA-150 (urea) and IDH were the lowest, exhibiting glass transitions of about 84-93° C. The composites of the compositions containing CA-150 (urea) and CDH performed better, with a T_{g} of about 138° C., but was still lower than all other compositions tested, with the exception of 3,3′-DDS and BCl₃ curative composition.

In contrast, the composites of the compositions containing 3,3′-DDS and BF₃, the imidazole, dicy, CDH, and IDH each exhibited glass transition temperatures which were each higher than the CA-150 (urea) containing compositions, ranging between about 149-159° C. Furthermore, composites of the CDH and IDH compositions exhibited the highest glass transition temperatures of all the composites tested, about 159° C. which was about 31-66° C. higher than that of the CA-150 (urea) containing compositions.

### SUMMARY

Urea type component-amine curing systems, alone or in combination with hydrazines, exhibited high degrees of initial cure but relatively poor mechanical performance, as evaluated through compression after impact, open hole compression, and wet glass transition temperature testing. Compositions of the present invention containing hydrazine-amine curing systems (with CDH and IDH) without urea type components, exhibited a reduced level of initial cure as compared to the urea containing compositions. However, this level of initial cure was comparable to other curing agents such as BF₃, BCl₃, imidazole, and dicy. Furthermore, the level of initial cure, approximately 50-60% is adequate to enable composite components to retain their form when unsupported, enabling free-standing post-cures without distortion of the composite part. Furthermore composites of hydrazine-amine curing system compositions of the present invention exhibited significantly better mechanical performance than all other compositions evaluated under hot and wet conditions (e.g., open hole compression strength and glass transition temperature). These mechanical property improvements are significant, as hot and wet conditions represent worst case design scenarios and are critical for practical application of composite and adhesive systems.

### Example 2

### Tack Life

The tack life of epoxy polymer compositions comprising the novel curing agents of the present invention were compared with that of other curing agents. The performance of each prepreg composition was characterized through tack life measurements and degree of cure measurements. As discussed below, the prepreg of polymer compositions comprising hydrazine-amine curing systems of the present invention exhibited a significant degree of cure at low temperature while concurrently preserving good tack life as compared to prepreg of the other compositions investigated.

Six compositions were evaluated. Compositions 9-12 included 3,3′-DDS alone or in combination with one of BF₃, BCl₃, and dicy as curing agents. The BF₃ comprised Anchor 1115, while the BCl₃ comprised DY9577 or GY6010/BCl₃ and the dicyandiamide comprised Amicure CG-1400. Compositions 13-14 included 3,3′-DDS in combination with IDH and CDH, respectively, as curing agents.

Each of the compositions evaluated also contained two epoxy resins and a substantially soluble thermoplastic polymer toughening agent. The epoxy resins comprised tetraglycidyl diamino diphenylmethane (MY721, epoxy equivalent weight (EEW) about 112; Huntsman Advanced Materials) and 4-glycidyloxy-N,N-Diglycidylaniline (MY0510, EEW about 101; Huntsman Advanced Materials). The high molecular weight polymer, a soluble thermoplastic polymer, comprised KM180 (Cytec Engineering Materials).

Each of these compositions are illustrated below in Table 2:

TABLE 2
Compositions of Example 2

| | Concentration (wt. %) | | | | | |
|---|---|---|---|---|---|---|
| | or Stoichiometry (%) | | | | | |
| Component | 10 | 11 | 12 | 13 | 14 | 15 |
| MY721 conc. | 26.08 | 25.88 | 25.23 | 25.75 | 25.32 | 25.72 |
| MY0510 conc. | 26.08 | 25.88 | 25.23 | 25.75 | 25.32 | 25.72 |
| KM180 conc. | 20 | 20 | 20 | 20 | 20 | 20 |
| 3,3′-DDS conc. | 27.84 | 27.24 | 26.54 | 27.48 | 27.04 | 27.47 |
| 3,3′-DDS stoich. | 90% | 90% | 90% | 90% | 90% | 90% |
| BF₃ conc. | | 1 | | | | |
| BCl₃ conc | | | 3 | | | |
| Amicure CG- | | | | 1.02 | | |
| 1400 | | | | | | |
| (Dicyandiamide) | | | | | | |
| conc | | | | | | |
| Amicure CG- | | | | 10% | | |
| 1400 stoich | | | | | | |
| IDH conc | | | | | 2.32 | |
| IDH stoich | | | | | 10% | |
| CDH conc | | | | | | 1.09 |
| CDH stoich | | | | | | 10% |

Approximately 2400 g batches of each epoxy polymer composition were fabricated as follows. MY721 and MY0510 epoxy resins were added to a mixing vessel. The mixing vessel was then placed into an oil bath at a temperature of about 70° C. and mixing was begun. Next, about the KM180 thermoplastic was added to the resin mixture. The oil bath temperature was increased to about 116° C. in order to allow the KM180 to dissolve into the resin, followed by cooling to approximately 71° C. Subsequently, 3,3′-DDS, at about a 90% stoichiometry level, was added to the resin mixture The remaining curing agent was then mixed into the resin. The epoxy polymer composition was then poured out of the mixing vessel and allowed to cool.

### (a) Degree of Cure

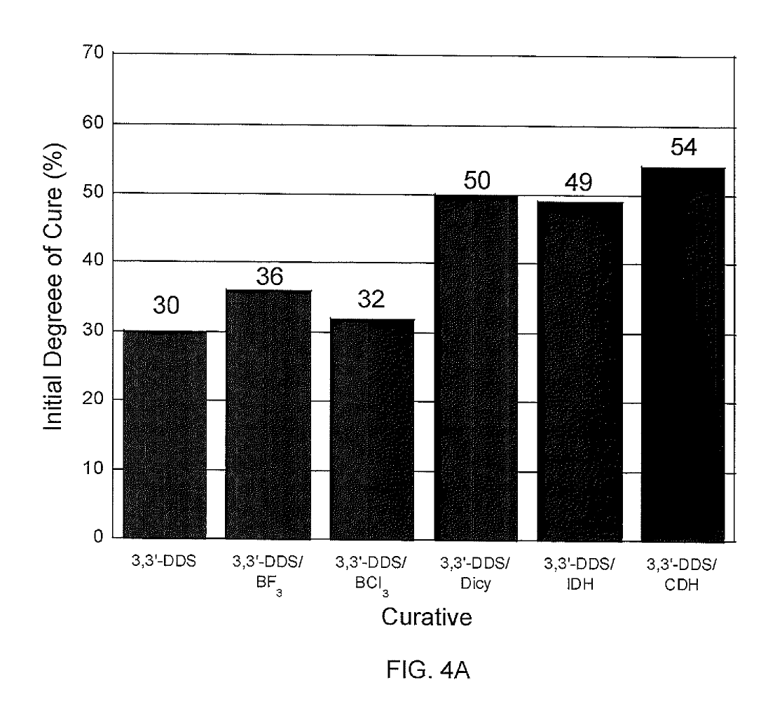

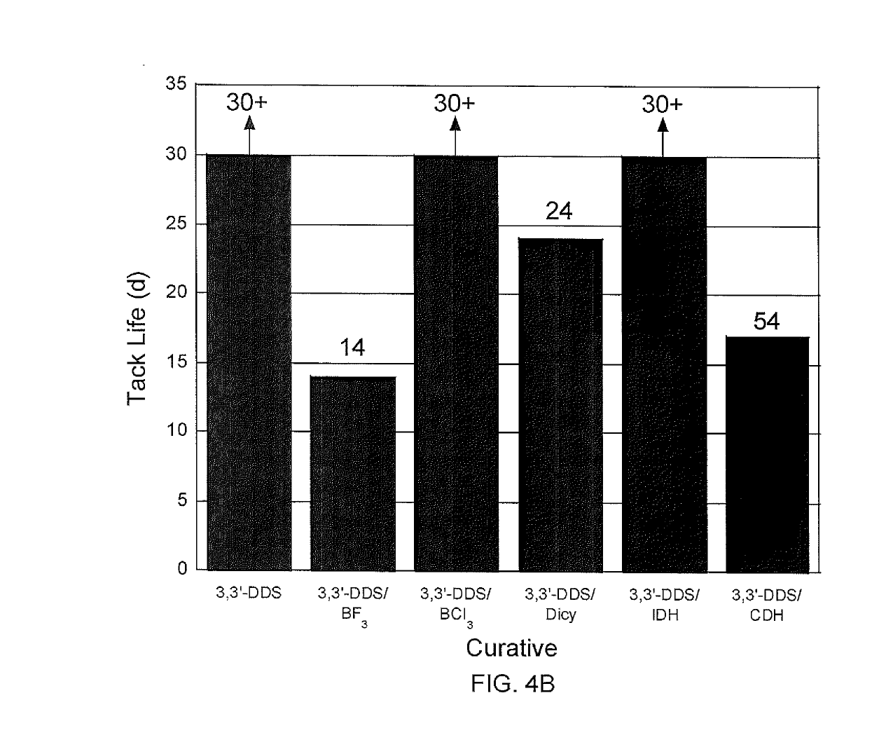

Degree of cure was measured by DSC testing, as discussed above with respect to Example 1, except that the hold time period was selected to be about 8 hours at about 93° C. FIG. 4A illustrates the degree of cure obtained for compositions 9-14.

From FIG. 4A, it may be observed that the values of degree of cure varied from about 30 to 54%. 3,3′-DDS alone and in combination with BF₃, and BCl₃ exhibited the lowest degrees of cure, about 30-36%. The compositions containing 3,3′DDS in combination with dicy, IDH, and CDH, however, exhibited higher initial degrees of cure, ranging between about 49-54%.

### (b) Tack Life

The tack life of the epoxy polymer compositions was investigated to determine their long term stability. Tack life evaluations were performed by touch at about 22° C. Samples were prepared by flattening out an approximately 5 gram sample of each resin composition in a press to a thickness of about 1-2 mm. The samples were then aged at ambient temperature, about 22° C. to 25 C, and examined every 2-3 days for up to 30 days. The tack life was the time at which the sample did not substantially exhibit tack to the touch.

FIG. 4B illustrates the tack life measured for compositions 10-15. The observed tack life varied from about 14 to greater than 30 days. 3,3′-DDS in combination with BF₃, CDH or dicy exhibited the lowest tack life, at about 14-24 days. The compositions containing 3,3′-DDS alone, 3,3′-DDS and BCl₃, or 3,3′-DDS and IDH, each exhibited higher tack life of greater than 30 days.

### SUMMARY

Of the epoxy polymer compositions evaluated in Example 2, 3,3′-DDS in combination with dicy, CDH, or IDH exhibited the highest degrees of initial cure. Of these, 3′3-DDS in combination with IDH exhibited the highest measured tack life, greater than about 30 days, while 3′3-DDS in combination with CDH exhibited an acceptable tack life of about 17 days.

These results, in combination with the superior mechanical properties illustrated in Example 1, demonstrate the benefits which may be achieved through compositions containing hydrazine-amine curing systems over previously developed curing systems.

### Example 3

### Mechanical Performance of Carbodihydrazide (CDH) Containing Hydrazine-Amine Curing System Compositions as a Function of Stoichiometry Level

Having established the utility of the hydrazine-amine curing systems disclosed herein for use in epoxy polymer compositions, further investigations were performed to evaluate the effect of the hydrazine stoichiometry. The performance of four CDH containing epoxy polymer compositions was characterized through degree of cure measurements and mechanical property measurements (OHC and T_{g}-wet), as discussed above.

The four compositions each contained 3,3′-DDS and CDH as hydrazine-amine curing system, in varying stoichiometry levels, with the total stoichiometry level kept constant at about 80%. CDH stoichiometry levels examined were about 7, 10, 20, and 40%.

Each of the compositions evaluated contained two epoxies and a substantially soluble thermoplastic toughening agent. The epoxy resins comprised tetraglycidyl diamino diphenylmethane (MY721, epoxy equivalent weight (EEW) about 112; Huntsman Advanced Materials) and 4-glycidyloxy-N,N-Diglycidylaniline (MY0510, EEW about 101; Huntsman Advanced Materials). The high molecular weight polymer, a soluble thermoplastic polymer, comprised KM180 (Cytec Engineered Materials).

Each of these compositions are illustrated below in Table 3:

TABLE 3
Compositions of Example 3

Concentration (wt. %)
or Stoichiometry (%)

| Component | 16 | 17 | 18 | 19 |
|---|---|---|---|---|
| MY721 conc. | 37.03 | 37.33 | 38.33 | 40.51 |
| MY0510 conc. | 18.52 | 18.66 | 19.17 | 20.26 |
| KM180 conc. | 20 | 20 | 20 | 20 |
| 3,3′-DDS conc. | 23.64 | 22.84 | 20.11 | 14.17 |
| 3,3′-DDS stoich. | 73% | 70% | 60% | 40% |
| CDH conc | 0.81 | 1.17 | 2.39 | 5.06 |
| CDH stoich | 7% | 10% | 20% | 40 |

Approximately 2400 g batches of each epoxy resin composition were fabricated as follows. MY721 and MY0510 epoxy resins were added to a mixing vessel. The mixing vessel was then placed into an oil bath at a temperature of about 70° C. and mixing was begun. Next, the KM180 thermoplastic was added to the resin mixture. The oil bath temperature was increased to about 116° C. in order to allow the KM180 to dissolve into the resin, followed by cooling to approximately 71° C. Subsequently, 3,3′-DDS, at the specified stoichiometry level, was slurried into the resin mixture. The remaining curing agent was then mixed into the resin. The epoxy polymer composition was then poured out of the mixing vessel and allowed to cool.

The compositions so fabricated were filmed and made into prepregs comprising a polyacrylonitrile (PAN)-based fiber, IM7, having an areal fiber weight of about 145 g/m² and a resin content of approximately 33 wt %.

Carbon fiber/epoxy composites were made from these prepregs by laying up the prepreg in an orientation and size to the specifications of each test. The prepreg layups were subjected to vacuum and heat to cure the layup and form the final composite structure. The prepreg layups were initially cured in an autoclave by heating at a rate of about 0.55° C./min to approximately 93° C. under a vacuum envelope with an applied pressure of about 100 psi. The prepreg was subsequently heat treated at about 93° C. for about 16 hrs to provide an initial cure and then cooled.

After this initial cure, the degree of cure was evaluated by DSC. A free standing post-cure was then completed by heating the composites in an oven, without vacuum or pressure, at about 1.7° C./min to a temperature of about 176° C. and held at about 176° C. for approximately 6 hrs.

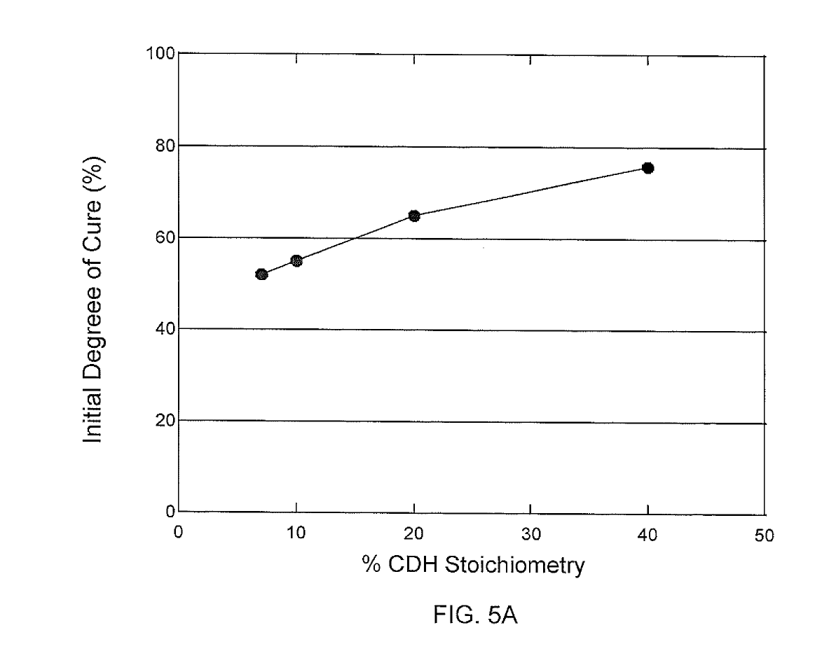

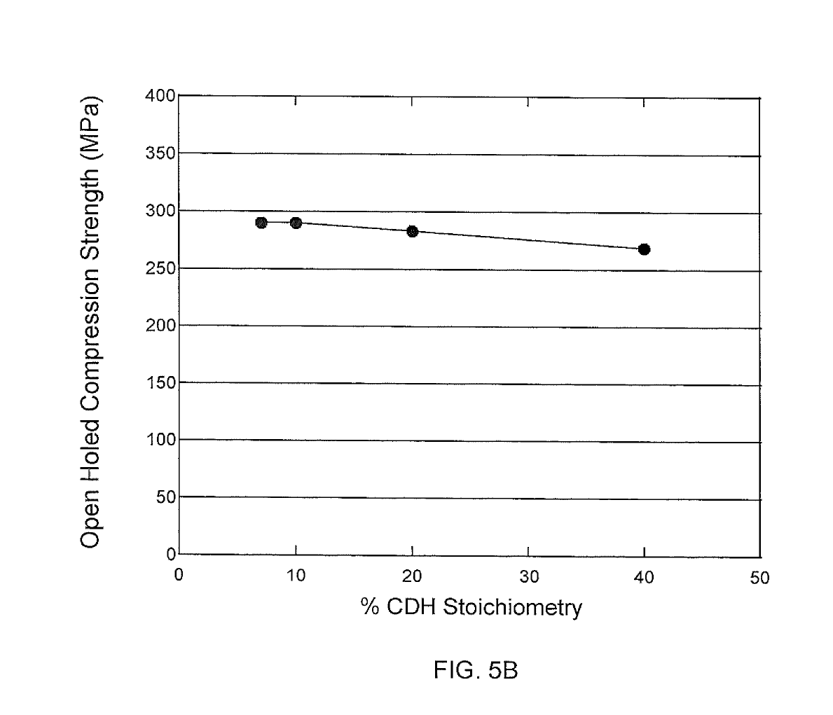

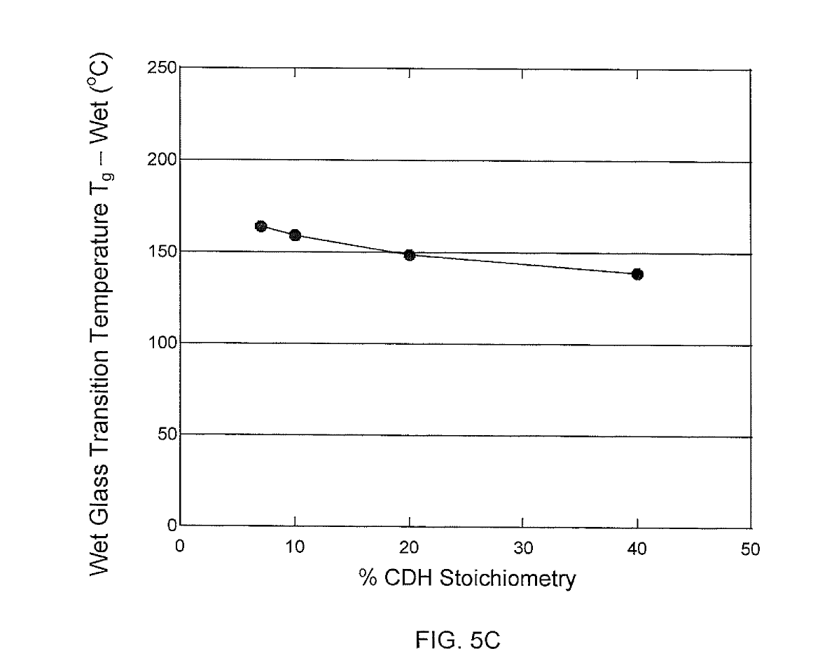

FIG. 5A illustrates the initial degree of cure before post cure obtained for Compositions 16-19. It may be observed that the values of degree of cure increased from about 52 to 76% with increasing CDH stoichiometry.

FIGS. 5B and 5C give the open hole compression strength and wet glass transition temperature, respectively. It may be observed that each of these properties exhibit modest declines with increasing CDH stoichiometry. For example, open hole compression strength decreases from about 290 to 269 MPa, approximately 7%. Similarly, wet glass transition temperature decreases from about 164 to 139° C.

Thus, it may be seen that hydrazine-amine based curing systems of the present invention provide a wide degree of flexibility with respect to initial degree of cure. By employing relatively low stoichiometry levels, degree of cure values in the 50% range may be attained with only a 93° C. initial cure, while at higher stoichiometry values, degree of cure values in the 70% range may be attained. This variation in initial degree of cure is attained with modest impact upon hot and wet mechanical properties, providing manufacturers with the freedom to adjust degree of cure by a wide range or accelerate or shorten cure times without impacting mechanical properties significantly.

This observation is in notably contrast to other compositions, such as 3,3′-DDS and urea in combination with hydrazines (e.g., Example 1) where it was observed that compositions demonstrating relatively high degrees of cure yielded composites with relatively poor mechanical properties.

### Example 4

### Mechanical Performance of 3,3′-DDS and Isophthalic Dihydrazide (IDH) Hydrazine-Amine Curing System as a Function of Initial Cure Conditions

Additional investigations were performed to evaluate the effect of initial cure conditions on degree of cure and T_{g}-wet in compositions employing IDH and 3,3′-DDS as hydrazine-amine curing system. The performance of each epoxy polymer composition was characterized through degree of cure measurements and mechanical property measurements (hot/wet OHC and T_{g}-wet), as discussed above.

Each of the epoxy polymer compositions further contained two epoxy resins and a substantially soluble high molecular weight polymer, a thermoplastic toughening agent. The epoxy resins comprised tetraglycidyl diamino diphenylmethane (MY721, epoxy equivalent weight (EEW) about 112; Huntsman Advanced Materials) and 4-glycidyloxy-N,N-Diglycidylaniline (MY0510, EEW about 101; Huntsman Advanced Materials). The high molecular weight polymer, a soluble thermoplastic polymer, comprised KM180 (Cytec Engineered Materials). The relative amounts of these components are given below in Table 4:

TABLE 4
Composition of Example 4

| | Conc. (wt. %) Stoich (%) |
|---|---|
| Component | 20 |
| MY721 conc. | 17.81 |
| MY0510 conc. | 33.06 |
| KM180 conc. | 22 |
| 3,3′-DDS conc. | 25.57 |
| 3,3′-DDS stoich. | 90% |
| IDH conc | 1.56 |
| IDH stoich | 7% |

Approximately 2400 g batches of each epoxy polymer composition were fabricated as follows. MY721 and MY0510 epoxy resins were added to a mixing vessel. The mixing vessel was then placed into an oil bath at a temperature of about 70° C. and mixing was begun. Next, the KM180 thermoplastic was added to the resin mixture. The oil bath temperature was increased to about 116° C. in order to allow the KM180 to dissolve into the resin, followed by cooling to approximately 71° C. Subsequently, 3,3′-DDS was slurried into the resin mixture. The remaining curing agent was then mixed into the resin. The epoxy polymer composition was then poured out of the mixing vessel and allowed to cool.

The compositions so fabricated were filmed and made into prepregs comprising a polyacrylonitrile (PAN)-based fiber, IM7 having an areal fiber weight of about 145 g/m² and a resin content of approximately 33 wt %.

Carbon fiber/epoxy composites were made from these prepregs by laying up the prepreg in an approximately [0/90]₄ₛ orientation and sized to the specifications of each test. The prepreg layups were subjected to vacuum and heat to cure the layup and form the final composite structure. The prepreg layups were initially cured in an autoclave by heating at a rate of about 0.55° C./min to a selected temperature ranging between about 121 to 149° C. under a vacuum envelope with an applied pressure of about 100 psi. The prepreg was subsequently heat treated at this temperature for about 2 or 4 hrs to provide a low temperature cure and then cooled.

After this low temperature cure, the degree of cure was evaluated by DSC and T_{g}-wet of the composites was evaluated. Wet conditioning was performed by submerging the samples in water at about 71° C. for about 2 weeks.

### (a) Degree of Cure

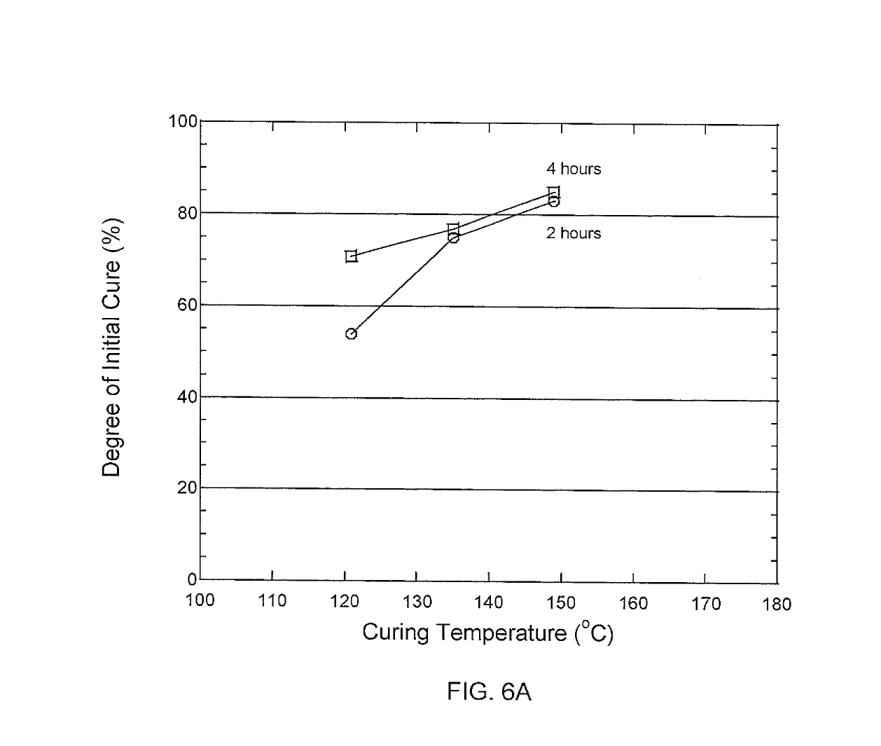

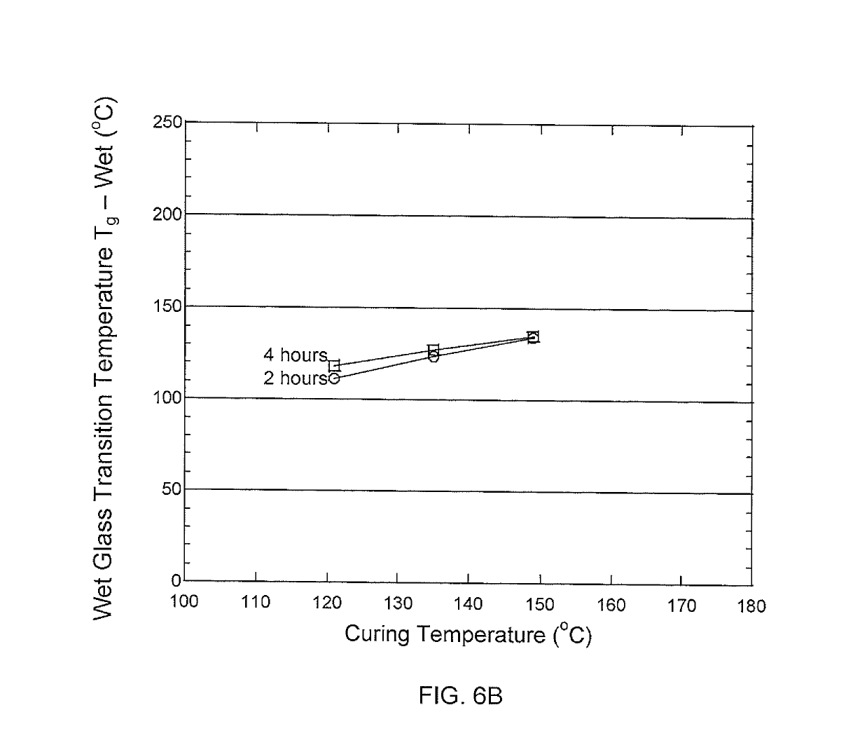

Degree of cure was measured by DSC testing, as discussed above with respect to Example 1 as a function of cure time and temperature. FIG. 6A illustrates the degree of cure obtained for Composition 20 as a function of cure temperature and time.

From FIG. 6A, it may be observed that as the curing temperature was increased from about 121 to 149° C., the degree of cure changed from about 50 to 83% at about 2 hours, an increase of about 65%. When cured for 4 hours at the same temperatures, the degree of cure changed from about 70 to 85%, an increase of about 20%. Furthermore, while there was a significant increase in degree of cure changing from 2 to 4 hour heat treatments at about 121° C., this difference was significantly reduced the middle to upper range of curing temperatures evaluated.

(b) Glass Transition Temperature-Wet (T_{g}-wet)

T_{g}-wet testing was performed as discussed above with respect to Example 1 as a function of curing temperature and time. The measured glass transition temperatures increased from about 110 to 135° C. as the curing temperature increased from 121 to 149° C.

### SUMMARY

This example shows that 3,3′-DDS and IDH as the hydrazine-amine curing system of the present invention gives a high degree of cure at relatively low temperatures. Curing temperature and time were observed to have an influence on the degree of cure and wet glass transition temperature of composites formed from resins comprising 3,3′-DDS and IDH curing agents. In one aspect, both degree of cure and T_{g}-wet were observed to increase with increasing curing temperature. Measured values of degree of cure and T_{g}-wet with curing hold time were generally lower after a 2 hour hold time as compared with a four hour hold time. The difference in properties was most pronounced at low curing temperatures, reducing significantly with increasing curing temperature. These results illustrate that for the curing times and temperatures studied, IDH compositions are relatively insensitive to curing hold time at intermediate to high initial cure temperatures. Furthermore, good T_{g}-wet properties, about 110-135° C., may be achieved with high degree of initial cure, about 55-85%.

What is claimed is:

1. A epoxy polymer composition, comprising:
one or more epoxy resins;
a hydrazine-based curing agent in less than 50% stoichiometry based upon the epoxy resins equivalent weight; and
an amine-based curing agent in greater than 30% stoichiometry based upon epoxy resins equivalent weight.

2. The polymer composition of claim 1, wherein the hydrazine-based curing agent comprises a hydrazide.

3. The polymer composition of claim 2, wherein the hydrazide is selected from the group consisting of hydrazides, dihydrazides, trihydrazides, tetrahydrazides, carbodihydrazide (CDH), isophthalic dihydrazide (IDH), phthalic dihydrazide, terephthalic dihydrazide, adipic dihydrazide (ADH), 1,2,3-benzenetricarboxic trihydrazide, trimellitic trihydrazide, trimesic trihydrazide, aromatic monohydrazides, aliphatic monohydrazides, aliphatic monohydrazides, aliphatic dihydrazides, sebaic acid dihyrazide, aliphatic trihydrazides, aliphatic tetrahydrazides, aromatic monohydrazides, aromatic dihydrazides, aromatic trihydrazides, aromatic tetrahydrazides naphthanoic acid hydrazide, naphthalene dicarboxylic acid dihydrazide.

4. The polymer composition of claim 2, wherein the hydrazide comprises one or more of acyl hydrazides and sulfonyl hydrazides.

5. The polymer composition of claim 1, wherein the polymer composition achieves a degree of cure of about 40% or greater after heat treatment at about 70 to 150° C. for about 0.5 to 24 h.

6. The polymer composition of claim 1, wherein the epoxy resins comprise di-functional or multi-functional epoxy resins.

7. The polymer composition of claim 1, wherein the hydrazine-based curing agent has a melting temperature greater than about 50° C. and the amine curing agent is a liquid or is dissolved into the epoxy resins.

8. The polymer composition of claim 1, wherein the hydrazine-based curing agent is a liquid or is dissolved into the epoxy resins and the amine-based curing agent has a melting temperature greater than about 50° C.

9. The polymer composition of claim 1, wherein the hydrazine-based curing agent has a melting temperature greater than about 50° C. in the epoxy resins and the amine-based curing agent has a melting temperature greater than about 50° C. the epoxy resins.

10. The polymer composition of claim 1, wherein the amine-based curing agent comprises one or more of 3,3′-diaminodiphenyl sulfone (3,3′-DDS), 4,4′-diaminodiphenyl sulfone (4,4′-DDS), 9,9-bis(3-chloro-4-aminophenyl)fluorine (CAF), aniline, 4,4′-diaminobensophenone, and 2,2-Bis [4-(4-aminophenoxy)phenyl] propane (BAPP).

11. The polymer composition of claim 1, further comprising a high molecular weight polymer in a concentration up to about 50 wt. % on the basis of the total weight of the polymer composition.

12. The polymer composition of claim 11, wherein the high molecular weight polymer comprises at least one of vinylic resins, polyamides, phenoxy, polyacetal, polyaramid, polyester, polyacetal, polycarbonate, poly(phenylene oxide), poly(phenylene sulfide), polyallylate, polybenzimidazole, polyimide, polyamideimide, polyetherimide, polysulfone, polyethersulfone, polyether ether ketone, polyaramid, polybenzimidazole, hydrocarbon resins, cellulose derivatives, carboxy-terminated butadieneacrylonitrile, amine-terminated butadieneacrylonitrile, fluorocarbon elastomers, and silicone elastomers.

13. A method of forming a polymer composition, comprising:
providing one or more epoxy resins;
providing a hydrazine-based curing agent in less than 50% stoichiometry based upon the epoxy resins equivalent weight; and
providing an amine-based curing agent in greater than 30% stoichiometry based upon the epoxy resins equivalent weight; and
combining the epoxy resins, hydrazine-based curing agent, and amine-based curing agent into a substantially homogeneous mixture.

14. The method of claim 13, wherein the hydrazine-based curing agent possess a hydrazine functional group of the formula: 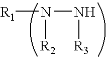
where R₁, R₂, and R₃ are each independently selected from hydrogen or a substituent.

15. The method of claim 13, comprising a hydrazine-based curing agent selected from the group consisting of hydrazinium benzoate, hydrazinium chloride, hydrazinium difluoride, acyl hydrazides, sulfonyl hydrazides, and substituted sulfonyl hydrazides.

16. The method of claim 13, further comprising combining at least one high molecular weight polymer present in a concentration ranging between about 1-40 wt. % on the basis of the total weight of the polymer composition.

17. The method of claim 16, wherein the at least one high molecular weight polymer is substantially insoluble in the polymer composition.

18. The method of claim 17, wherein at least one high molecular weight polymer comprises polyether ether ketone (PEEK), polyether ketone ketone (PEKK), P84, polyphenylene oxide (PPO) and CTBN rubber.

19. The method of claim 13, wherein the hydrazine-based curing agent comprises a hydrazide selected from the group consisting of carbodihydrazide (CDH), isophthalic dihydrazide (IDH), phthalic dihydrazide, terephthalic dihydrazide, adipic dihydrazide (ADH), 1,2,3-benzenetricarboxic trihydrazide, trimellitic trihydrazide, trimesic trihydrazide, aromatic monohydrazides, aliphatic monohydrazides, aliphatic monohydrazides, aliphatic dihydrazides, sebaic acid dihyrazide, aliphatic trihydrazides, aliphatic tetrahydrazides, aromatic monohydrazides, aromatic dihydrazides, aromatic trihydrazides, and aromatic tetrahydrazides.

20. The method of claim 13, wherein the amine-based curing agent comprises one or more of dicyandamide (dicy), 3,3′-diaminodiphenyl sulfone (3,3′-DDS), 4,4′-diaminodiphenyl sulfone (4,4′-DDS), 9,9-bis(3-chloro-4-aminophenyl)fluorine (CAF), aniline, 4,4′-diaminobensophenone, and bis(3-aminopropyl)piperazine (BAPP).
